(19) United States
(12) Patent Application Publication
(10) Pub. No.: US 2025/0233342 A1
(43) Pub. Date: Jul. 17, 2025

(54) IMPROVED ELECTRICAL CONNECTION OUTLET HAVING EXTENDED SAFETY AND CONTROL FUNCTIONS

(71) Applicant: MARECHAL ELECTRIC, SAINT-MAURICE (FR)

(72) Inventor: Abdel Mounim HOUIR ALAMI, Paris (FR)

(73) Assignee: MARECHAL ELECTRIC, SAINT-MAURICE (FR)

(21) Appl. No.: 18/702,771

(22) PCT Filed: Oct. 17, 2022
(86) PCT No.: PCT/FR2022/051957

§ 371 Date: Apr. 18, 2024

(30) Foreign Application Priority Data
Oct. 19, 2021 (FR) 2111095

(51) Int. Cl. H01R 13/447; H01R 13/627; H01R 13/629

(52) U.S. Cl. CPC H01R 13/447; H01R 13/6275; H01R 13/62977

(57) ABSTRACT

An electrical connection mount (100) comprising a locking element (130), movable between a locking position, an engagement position and an open position, said electrical connection mount (100) comprising an actuator (140) movable between an engaged position and a disengaged position, of locking (130) interacts with the actuator (140), in such a way that the locking element (130) prevents the actuator (140) from passing into its engaged position when it is in its open position or in its locking position, and allows the actuator (140) to pass into its engaged position when it is in its engagement position, and the actuator (140) prevents the change of position of the locking element (130) when it is in its open position, and allows the change of position of the locking element (130) when it is in its engaged position.

### TECHNICAL FIELD

This summary relates to electrical connectors for high-power electric currents, and in particular sockets equipped with improved safety means for such electric currents.

### PRIOR ART

Sockets for high-power currents equipped with hooks are known. These hooks are used to perform a function of mechanical retainment of a plug in the engaged position, corresponding to the passing of current through the socket, and/or retainment of a cover of the socket in position. The document FR2270696 thus presents an example of such a device.

However, the transmission of high-power currents poses many problems in terms of safety.

This invention thus has the aim of extending the functionality associated with such retaining hooks.

### SUMMARY OF THE INVENTION

To at least partially solve these problems, this summary relates to an electrical connection mount, suitable for receiving a complementary mount for making an electrical connection,
said connection mount comprising
   a body defining an inner volume suitable for receiving a complementary mount,
   a cover movable between a shutting position in which it shuts off said inner volume, and a connection position in which it uncovers said inner volume,
   a locking element, movable between:
      a locking position, in which it retains the cover in the shutting position,
      an engagement position, in which it retains a complementary mount engaged with the electrical connection mount,
      an open position, in which it allows the displacement of the cover or of a complementary mount with respect to the electrical connection mount,
said electrical connection mount comprising an actuator movable between an engaged position and a disengaged position, suitable for
   in the engaged position, transmitting a signal permitting the transmission of power via the electrical connection mount,
   in the disengaged position, transmitting a signal prohibiting the transmission of power via the electrical connection mount
characterized in that the locking element interacts with the actuator, in such a way that
   the locking element prevents the actuator from passing into its engaged position when it is in its open position or in its locking position, and allows the actuator to pass into its engaged position when it is in its engagement position
   the actuator prevents the change of position of the locking element when it is in its open position, and allows the change of position of the locking element when it is in its engaged position.

According to an example, the locking element comprises a hook, suitable for selectively engaging the cover or a complementary mount, and a lever rotationally movable with respect to the hook between a first position in which it prevents the change of position of the actuator, and a second position in which it allows the change of position of the actuator.

The lever is then typically configured in such a way as to be retained in its first position when the locking element is in its locking position or in its open position, and to be in its second position when the locking element is in its engagement position.

According to an example, the hook and the lever are elements mounted on an outer surface of the body of the electrical connection mount.

According to an example, the actuator comprises a cam and a button coupled in displacement along an actuator axis, the lever being suitable for selectively immobilizing the cam when it is in its first position, or permitting a change of position of the cam when it is in its second position.

According to an example, the actuator is coupled to an indicator light, suitable for emitting a light signal when the actuator is in its engaged position.

According to an example, the electrical connection mount further comprises a lock, movable between a locked position in which it prevents the change of position of the actuator, and an unlocked position in which it permits the change of position of the actuator.

This summary also relates to an electrical connection mount as previously defined associated with a current source, the current source comprising a controller suitable for controlling the supply of current,
the actuator (140) being configured in such a way as to, in its engaged position, transmit to the controller a signal permitting the transmission of power via the connection mount, and in its disengaged position, transmit to the controller a signal prohibiting the transmission of power via the connection mount.

In this summary, a socket mount forms a female part which can belong to a current socket (in which the socket mount is generally secured to a wall, a casing, or equivalent), an extension, or a connector (in which the socket mount is generally part of a socket) whereas a connector mount forms a male part which can belong to a current socket (in which the connector socket is generally part of the plug), an extension, or a connector (in which the connector mount is generally secured to an appliance or equivalent.)

In general, a socket comprises a socket mount and a handle or cowl secured to said socket mount; a plug comprises a connector mount and a handle or cowl secured to said connector mount; an extension is an assembly comprising a socket and a plug; a current socket is an assembly comprising a socket mount and a plug; a connector is an assembly comprising a socket and a connector mount. The handle or cowl can be incorporated into the socket mount or into the connector mount, in which case said socket or connector mount also forms a socket or a plug.

### BRIEF DESCRIPTION OF THE DRAWINGS

The invention and its advantages will be better understood on reading the detailed description given hereinafter of different embodiments of the invention given by way of non-limiting example.

FIG. 1 has a perspective view of an assembly according to an aspect of this invention.

FIG. 2 is a section view of FIG. 1.

FIG. 3 is a view of an assembly according to an aspect of this invention in a given configuration.

FIG. 4 is a view of an assembly according to an aspect of this invention in another given configuration.

FIG. 5 is a view of an assembly according to an aspect of this invention in another given configuration.

FIG. 6 is a view of an assembly according to an aspect of this invention in another given configuration.

FIG. 7 is a view of an assembly according to an aspect of this invention in another given configuration.

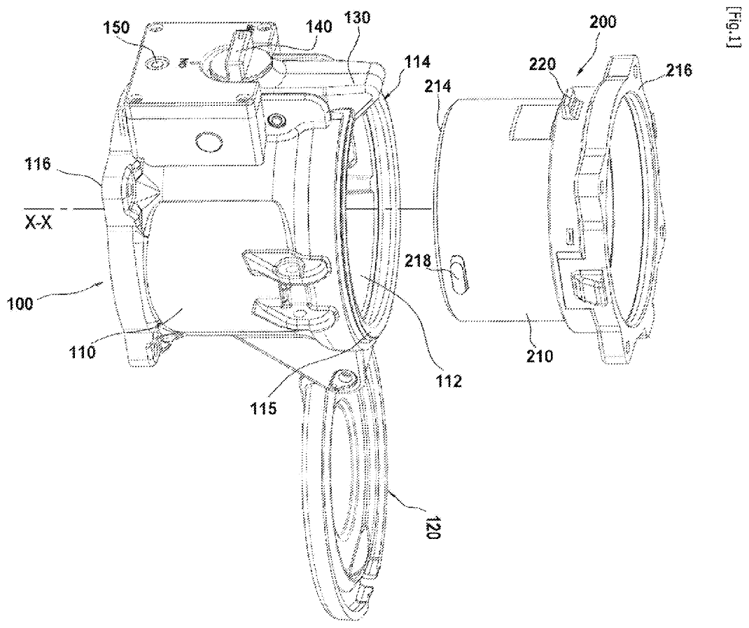

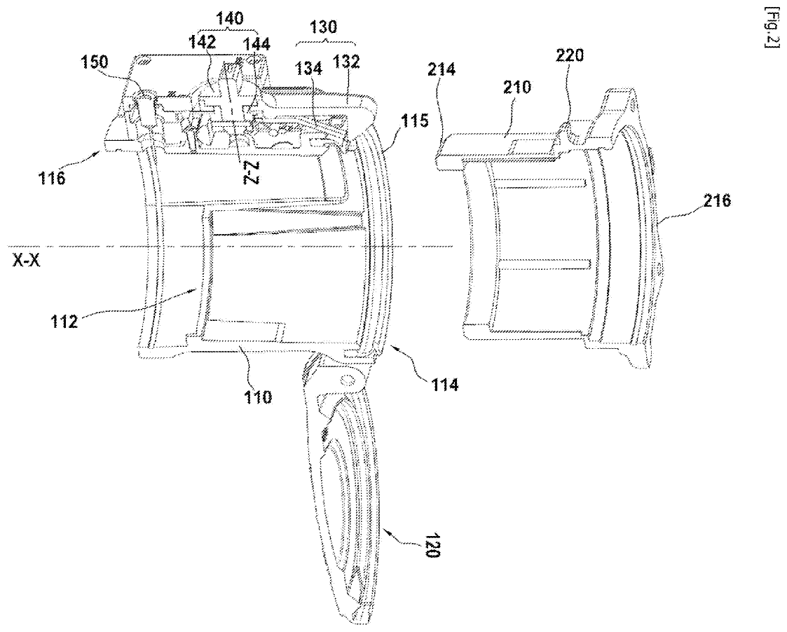

In all the figures, common elements are marked by identical reference numbers.

### DESCRIPTION OF THE EMBODIMENTS

Below is a description of different aspects of the invention with reference to the figures.

The figures show an electrical connection mount 100.

The electrical connection mount 100 as shown has a body 110 having a generally cylindrical revolution shape along a main axis X-X, defining an inner volume 112 suitable for receiving connecting elements, typically at least one orifice suitable for receiving a pin of a complementary mount. The body 110 has a proximal end 114 and a distal end 116, the naming of the ends as proximal and distal being arbitrary. The proximal end 114 is open, and is suitable for allowing the insertion of a complementary mount. The proximal end 114 is typically equipped with a seal 115, suitable for forming a watertight connection with a cover or with a complementary mount. The distal end 116 is connected to a component, for example a base, an electrical cabinet, an electrical cable or any other element supplying an electric current.

The body 110 comprises a cover 120, suitable for shutting off said inner volume, and therefore masking said connecting elements. The cover 120 is mounted pivotably, and is typically movable between a shutting position in which it masks said connecting elements, and a connection position in which it uncovers said connecting elements and thus enables the insertion of a complementary mount via the proximal end.

The electrical connection mount 100 is equipped with a locking element 130, suitable for selectively retaining the cover 120 in the shutting position or for allowing its opening, and also for retaining a complementary mount engaged in the electrical connection mount 100.

This figure also shows a complementary mount 200, suitable for being engaged with the electrical connection mount 100 to provide a passing of electric current. Here the complementary mount 200 is shown, comprising a body 210 having a proximal end 214 suitable for being inserted into the electrical connection mount 100 via its proximal end 114, and a distal end 216 typically connected to an appliance, a plug, or more generally an appliance for conducting or receiving an electric current. The complementary mount 200 typically comprises connecting elements such as plugs for the transfer of current, disposed in an inner volume of the body 210, and suitable for interacting with the connecting elements of the electrical connection mount 100 to produce a transfer of electric current.

The body 210 as shown comprises a stop 220, here in the form of a rib extending radially on an outer face of the body 210.

The locking element 130 of the electrical connection mount 100 is suitable for coming into engagement with the stop 220, to retain the complementary mount 200 in position when the latter is inserted into the electrical connection mount 100.

The body 210 of the complementary mount 200 is provided with indexing means 218, which are here formed by one or more ribs extending from the outer surface of the body 210 of the complementary mount 200, suitable for providing an angular indexation of the complementary mount 200 with respect to the electrical connection mount 100, such that the stop 220 is aligned with the locking element 130 when the complementary mount 200 is inserted into the electrical connection mount 100. The term “aligned” should be understood to mean that the locking element 130 and the stop 220 extend over a same angular sector with respect to an axis central to the complementary mount 200 and to the electrical connection mount 100.

The electrical connection mount 100 comprises an actuator 140, movable between an engaged position and a disengaged position, suitable for, in the engaged position, transmitting a signal permitting the transmission of power via the electrical connection mount 100, and in the disengaged position, transmitting a signal prohibiting the transmission of power via the electrical connection mount 100.

The actuator 140 is thus typically coupled to an electric current source via electric conductors that can be described as pilot contacts. The passing of a current via these electric conductors sends a signal to the current source, indicating to it that a transmission of power is permitted. The current source can then be actuated to deliver a current. The current source thus typically comprises a controller suitable for controlling the supply of current, and the actuator 140 is typically configured in such a way as to, in its engaged position, transmit to the controller a signal permitting the transmission of power via the electrical connection mount 100, and in its disengaged position, transmit to the controller a signal prohibiting the transmission of power via the electrical connection mount 100.

In the illustrated example, the actuator 140 comprises a button 142 coupled to a cam 144. The passing from the disengaged position to the engaged position is done by rotating the button 142 and the cam 144 about an actuator axis Z-Z. The actuator 140 is typically coupled to an indicator light 150, for example a light-emitting diode, suitable for emitting a light signal when the actuator 140 is in the engaged position or when an electric current is transmitted by the electrical connection mount 100.

The locking element 130 as proposed is movable between a locking position, an engagement position and an open position.

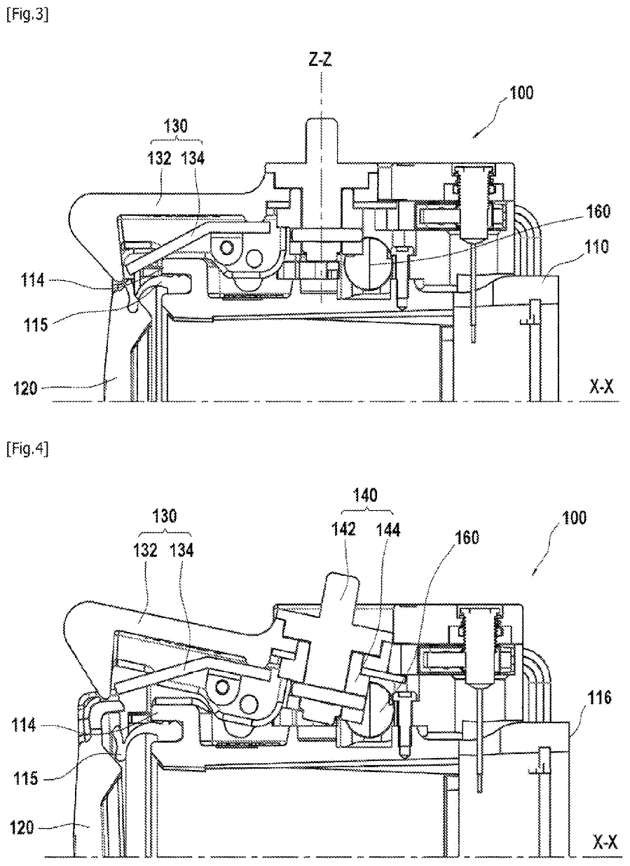

In its locking position, the locking element 130 retains the cover 120 in the shutting position. The electrical connection mount 100 is thus closed. FIG. 3 illustrates such a position.

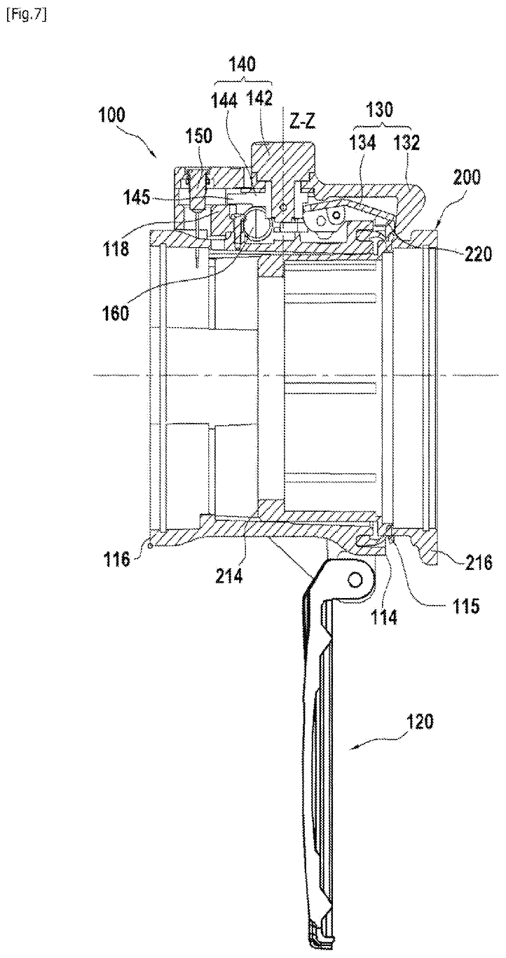

In its engagement position, the locking element 130 retains the complementary mount 200 engaged with the electrical connection mount 100. The electrical connection mount 100 and the complementary mount 200 are thus engaged in such a way as to allow a transmission of electric current. FIG. 7 illustrates such a position.

In its open position, the locking element 130 allows the displacement of the cover 120 from or toward its shutting position, or of the complementary mount 200 to bring it into a configuration of engagement with the electrical connection mount 100. FIGS. 4 and 6 illustrate such a position.

The locking element 130 as proposed interacts with the actuator 140 in such a way that the locking element 130 prevents the actuator 140 from passing into its engaged position when it is in its open position or into its locking position, and allows the actuator 140 to pass into its engaged position when it is in its engagement position, and the actuator 140 to prevent the chance of position of the locking element 130 when it is in its open position, and allows the change of position of the locking element 130 when it is in its engaged position.

The locking element 130 as proposed comprises a hook 132 and a lever 134. It will be understood that other embodiments are possible to fulfil the same function, and that this example is not limiting.

The hook 132 is mounted pivotably about a hook axis, and can typically be displaced along a limited angular sector, in such a way as to be able to alternate between a lowered position in which it engages the hook 120 or the stop 220 of the complementary mount 200 to retain them in position, and a raised position in which it allows the cover 120 or the complementary mount 200 to pass. The hook 132 is typically retained by default in its lowered position, for example by an elastic return means such as a spring.

The button 142 and the cam 144 of the actuator 144 are mounted rotationally movably about an actuator axis on the hook 132. Thus, the button 142 and the cam 144 are rotationally driven with the hook 132. It can thus be seen that when the locking element 130 is in its locking position or in its engagement position, the button 142 and the cam 144 are in a first position, whereas when the locking element 130 is in its open position, the button 142 and the cam 144 are in a second position.

The button 142 and the cam 144 are configured in such a way as to be rotationally immobilized about the actuator axis Z-Z when they are in the second position, i.e. when the locking element 130 is in its open position. Thus, the actuator 140 cannot change position between its engaged position and its disengaged position when the locking element 130 is in its open position.

The lever 134 as proposed is positioned between the hook 132 and the body 110 of the electrical connection mount 100. It is mounted pivotably about an axis of rotation parallel to the axis of rotation of the hook 132, and is movable between a first position and a second position with respect to the hook 132. The lever 134 is typically retained by default in its first configuration via return means, for example an elastic return means such as a spring.

The lever 134 interacts with the cam 144 of the actuator 140. In its first position, the lever 134 prevents the displacement of the cam 144, and therefore prevents a change of position of the actuator 140. In its second position, the lever 134 allows the displacement of the cam 144, and therefore allows a change of position of the actuator 140.

Thus, the position of the lever 134 determines the change of position of the actuator 140, and therefore determines whether or not it is possible to transmit an electric current.

The lever 134 is configured in such a way as to be in its first position when the locking element 130 is in its locking position or in its open position, and to be in its second position when the locking element 130 is in its engagement position.

Thus, the passing of the actuator 140 between its disengaged position and its engaged position is possible only when the locking element 130 is in its engaged position, i.e. when a complementary mount 200 is inserted into the electrical connection mount 100.

More precisely, if one refers to 3 to 7, one considers an initial situation in which the cover 120 is in its shutting position, which corresponds to the configuration shown on FIG. 3. The electrical connection mount 100 is thus in a position that is described as closed. The actuator 140 is in its disengaged position, and does not permit the supply of electric current to the electrical connection mount 100. The lever 134 prevents the changing of the actuator 140 position, and thus retains it in its disengaged position.

The user exerts a pressure on the locking element 130, which pivots the locking element 130 to bring it into its position illustrated in FIG. 4, and makes it possible to release the cover 120 to bring it into the connection position.

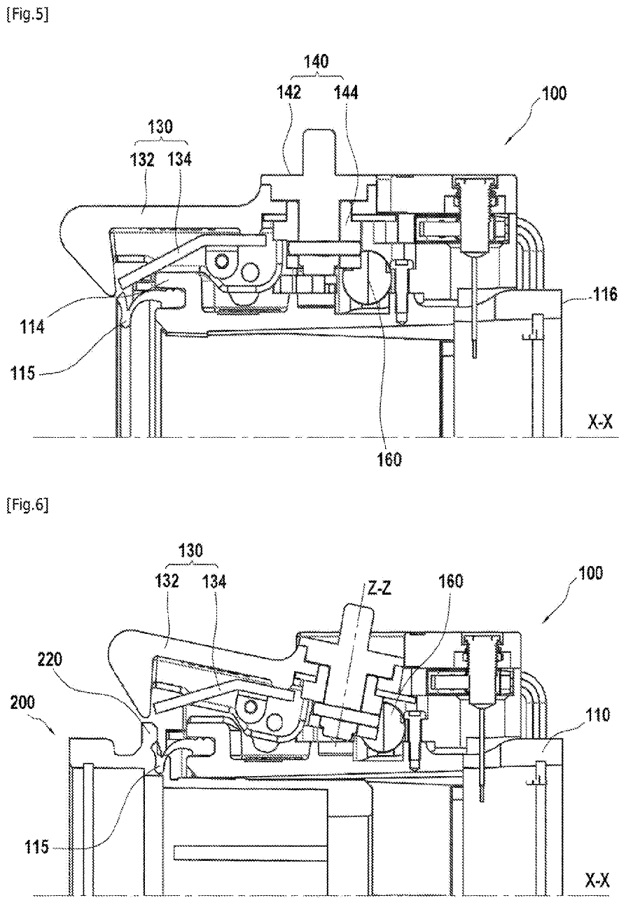

The locking element 130 then returns to its default position, which is the position illustrated in FIG. 5. The hook 132 is in its lowered position, and the lever 134 is in its first position. In this position, the actuator 140 is in its disengaged position, and does not permit the supply of electric current to the electrical connection mount 100.

When a user wishes to engage a complementary mount 200 in the electrical connection mount 100, he then inserts the proximal end 214 of the complementary mount 200 into the electrical connection mount 100 via its proximal end 114. The locking element 130 is then displaced; the hook 132 switches to its raised position, and brings the actuator 140 with it. The displacement of the locking element 130 is typically done by the user and/or by an interaction between the hook 132 and the stop 220 or any other suitable surface of the complementary mount 200. This configuration is schematically illustrated in FIG. 6. In this configuration, the lever 134 is in its first position with respect to the hook 132, and thus retains the actuator 140 in its disengaged position.

Once the complementary mount 200 has been inserted into the electrical connection mount 100, the locking element can be brought into its engagement position. This configuration is shown in FIG. 7. In this configuration, the hook 132 is in its lowered position, and then engages the stop 220. The lever 134 is meanwhile retained in its second position with respect to the hook 132, due to the stop 220 against which a free end of the lever 134 then bears. Thus, the lever 134 permits the rotation of the actuator 140, and therefore the passing of the actuator 140 between its disengaged position and its engaged position. The user can therefore pass the actuator into its engaged position to then make electric current pass.

Moreover, the cam 144 of the actuator 140 is typically configured in such a way as to prevent a change of position of the hook 132 of the locking element 130 when the actuator is in its engaged position. Thus, the locking element 130 is retained in its engagement configuration when the actuator 140 is in its engaged position. FIG. 7 shows such a retainment in position of the hook 132 by a free end 145 of the cam 144 which bears against a shoulder 118 of the body 110 of the electrical connection mount 100. Insofar as the electrical connection mount 140 is rotationally secured about the hook axis with the hook 132, this bearing thus prevents the rotational movement of the hook 132, and thus of the locking element 130.

The cam 144 of the actuator 140 is thus configured in such a way as to allow only one change of position of the hook 132 of the locking element 130 when the actuator 140 is in its disengaged position.

Thus, the association of the actuator 140 and of the locking element 130 makes it possible to permit the passing of current only when a complementary mount 200 is connected to the electrical connection mount 100, and to only allow the disengagement of the complementary mount 200 when the actuator 140 is in its disengaged position, i.e. when there is no electric current passing.

The locking element 130 and the actuator 140 as shown are positioned on an outer face of the body 110 of the electrical connection mount 100. Such an assembly on the outer face of the body 110 of the electrical connection mount 100 makes it possible to avoid affecting the tightness of the electrical connection mount 100.

The electrical connection mount 100 as shown can also comprise a lock 160, movable between a locked position in which it prevents the change of position of the actuator 140, and an unlocked position in which it permits the change of position of the actuator 140. The lock 160 can be actuated when the actuator 140 is in its engaged position, and thus retain it locked in its engaged position. As previously indicated, the actuator 140 in its engaged position prevents the change of position of the locking element 130, and thus prevents the disengagement of the electrical connection mount 100 with a complementary mount 200. The lock 160 is typically provided with a return means such as a spring, suitable for retaining it by default in its unlocked position.

The lock 160 can typically take the form of a rod mounted slidably with respect to the body 110 of the electrical connection mount 100, and suitable for then selectively engaging the cam 144 of the actuator 140 in order to permit its displacement or not. The lock 160 typically has a drill hole made in said rod which can in particular make it possible to insert a padlock into it, or any other element ensuring the locking in position of the lock 160. The addition of such a lock 160 thus makes it possible to fulfil a function of locking of the electrical connection mount 100 by retaining the locking element 130 typically in its engagement position, or optionally in its locking position.

The invention thus makes it possible to propose an electrical connection mount 100 comprising a locking element 130 having extended functionality. The locking element 130 as proposed here fulfils control and safety functions of the system. The control function provided makes it possible to ensure that the supply of current is only provided when a connection is correctly established.

Although this invention has been described with reference to specific embodiments, it is obvious that modifications and changes can be made to these examples without departing from the general scope of the invention as defined by the claims. In particular, individual features of the different embodiments illustrated/mentioned can be combined into additional embodiments. Consequently, the description and drawings must be considered in an illustrative sense rather than a restrictive one.

It is also obvious that all the features described with reference to a method are transposable, alone or in combination, to a device, and conversely, all the features described with reference to a device are transposable, alone or in combination, to a method.

1. An electrical connection mount for receiving a complementary mount for making an electrical connection, said electrical connection mount comprising:
a body defining an inner volume for receiving a complementary mount;
a cover movable between a shutting position in which the cover shuts off said inner volume and a connection position in which the cover uncovers said inner volume;
a locking element movable between:
a locking position in which the locking element retains the cover in the shutting position,
an engagement position in which the locking element retains a complementary mount engaged with the electrical connection mount, and
an open position in which the locking element allows the displacement of the cover or of a complementary mount with respect to the electrical connection mount; and
an actuator movable between an engaged position and a disengaged position, wherein
the actuator is configured to:
in the engaged position, transmit a signal permitting the transmission of power via the electrical connection mount, and
in the disengaged position, transmit a signal prohibiting the transmission of power via the electrical connection mount (100)
the locking element interacts with the actuator in such a way that:
the locking element prevents the actuator from passing into the engaged position when the locking element is in the open position or in the locking position, and allows the actuator to pass into the engaged position when the locking element is in the engagement position, and
the actuator prevents the change of position of the locking element when the locking element is in the open position, and allows the change of position of the locking element when the locking element is in the engagement position.

2. The electrical connection mount as claimed in claim 1, wherein the locking element comprises:
a hook for selectively engaging the cover or a complementary mount; and
a lever rotationally movable with respect to the hook between a first position in which the lever prevents the change of position of the actuator and a second position in which the lever allows the change of position of the actuator.

3. The electrical connection mount as claimed in claim 2, wherein the lever is configured in such a way as to be retained in the first position when the locking element is in the locking position or in the open position, and to be in the second position when the locking element is in the engagement position.

4. The electrical connection mount as claimed in claim 2, wherein the hook and the lever are elements mounted on an outer surface of the body of the electrical connection mount.

5. The electrical connection mount as claimed in claim 2, wherein the actuator comprises a cam and a button coupled in displacement along an actuator axis, the lever being for selectively immobilizing the cam when it is in its first position, or permitting a change of position of the cam when it is in its second position.

6. The electrical connection mount as claimed in claim 1, wherein the actuator is coupled to an indicator light for emitting a light signal when the actuator is in the engaged position.

7. The electrical connection mount as claimed in claim 1, further comprising a lock movable between a locked position in which the lock prevents the change of position of the actuator and an unlocked position in which the lock permits the change of position of the actuator.

8. An assembly comprising the electrical connection mount as claimed in claim 1 and a current source, wherein
the current source comprises a controller for controlling the supply of current, and
the actuator is configured to:
in the engaged position, transmit to the controller a signal permitting the transmission of power via the connection mount,
in the disengaged position, transmit to the controller a signal prohibiting the transmission of power via the connection mount.
